(19) United States
(12) Patent Application Publication
(10) Pub. No.: US 2021/0036906 A1
(43) Pub. Date: Feb. 4, 2021

(54) METHOD AND SYSTEM FOR CAMERA AUTHENTICATION USING A VIDEO MANAGEMENT SYSTEM

(71) Applicant: GENETEC INC., Sant Laurent (CA)

(72) Inventor: MATHIEU CHEVALIER, MONTREAL (CA)

(21) Appl. No.: 16/668,536

(22) Filed: Oct. 30, 2019

Related U.S. Application Data
(60) Provisional application No. 62/882,116, filed on Aug. 2, 2019.

(51) Int. Cl. H04L 29/06; H04W 12/06; H04L 9/08

(52) U.S. Cl. CPC H04L 29/06755; H04W 12/06; H04L 29/06721; H04L 29/06027; H04L 9/0819

(57) ABSTRACT

A video management server is connectable to a communication network and includes a processor, an interface and a memory operatively coupled to the processor and comprising computer-readable instructions executable by the processor. Execution of the instructions by the processor causes the video management server to carry out a method that comprises obtaining, via the interface, authentication credentials from a source external to the communication network, the authentication credentials being associated with a particular network device identifier of an image capture device; determining that a certain device purported to have the particular network device identifier is connected to the communication network; after the determining, attempting to authenticate, via the interface, the certain device over the communication network based on verification of prior knowledge of the authentication credentials by the certain device; and accepting, via the interface, video data received from the certain device over the communication network if authentication is successful.

### CROSS-REFERENCE TO RELATED APPLICATION

The present application claims the benefit under 35 U.S.C. 119(e) of U.S. Provisional Patent Application Ser. No. 62/882,116, filed on Aug. 2, 2019, hereby incorporated by reference herein.

### FIELD

The present application relates generally to video management systems and, in particular, to authentication of cameras connected to a video management system.

### BACKGROUND

Installation of security cameras for connection to a video management server via a network is typically a two-step process. Firstly, the cameras are physically set up and connected to the network, and then the cameras are configured (or enrolled). Frequently, the person or crew that is responsible for setup and connectivity is not the same person or crew that is responsible for enrollment. Moreover, the two steps may be separated by a significant time lag, on the order or minutes, days or even weeks. As such, those responsible for enrolling a device that appears to be a previously installed camera cannot be certain that the device is indeed a legitimate previously installed camera. In fact, without taking extra manual steps that may be burdensome and inefficient, the server may not be able to tell the difference between a legitimate camera and a malicious network device purporting to be such camera. As a result, during enrollment, certain sensitive information that may be requested of, or shared by, the video management server may fall into the wrong hands, compromising security and possibly leading to hacking of the server. The industry would therefore welcome a solution to this problem.

### SUMMARY

According to a first aspect, there is provided a method for execution by a video management server connectable to a communication network, comprising: obtaining authentication credentials from a source external to the communication network, the authentication credentials being associated with a particular network device identifier of an image capture device; determining that a certain device purported to have the particular network device identifier is connected to the communication network; after the determining, attempting to authenticate the certain device over the communication network based on verification of prior knowledge of the authentication credentials by the certain device; and accepting video data received from the certain device over the communication network if the attempting to authenticate is successful.

According to a second aspect, there is provided a video management server connectable to a communication network, comprising: a processor; an interface; a memory operatively coupled to the processor and comprising computer-readable instructions executable by the processor; wherein execution of the computer-readable instructions by the processor causes the video management server to carry out a method that comprises: obtaining, via the interface, authentication credentials from a source external to the communication network, the authentication credentials being associated with a particular network device identifier of an image capture device; determining that a certain device purported to have the particular network device identifier is connected to the communication network; after the determining, attempting, via the interface, a mutual authentication with the certain device over the communication network based on verification of prior knowledge of the authentication credentials by the certain device; and accepting, via the interface, video data received from the certain device over the communication network if the authentication is successful.

According to a third aspect, there is provided a non-transitory computer-readable medium comprising computer-readable instructions which, when executed by a processor of a video management server connectable to a communication network, cause the video management server to carry out a method that comprises: obtaining authentication credentials from a source external to the communication network, the authentication credentials being associated with a particular network device identifier of an image capture device; determining that a certain device purported to have the particular network device identifier is connected to the communication network; after the determining, attempting a mutual authentication with the certain device over the communication network based on verification of prior knowledge of the authentication credentials by the certain device; and accepting data received from the certain capture device over the communication network if the authentication is successful.

According to a fourth aspect, there is provided a computer-implemented method for facilitating management of a network of image capture devices, comprising: outputting a signal to cause a display to illustrate a plurality of icons respectively associated with a plurality of image capture devices, each icon being of a first type or of a second type, each icon of the first type corresponding to an installed but not yet authenticated image capture device and each icon of the second type corresponding to an authenticated image capture device; discovering through the network that a particular image capture device that is an installed but not yet authenticated image capture device has connected to the network; and in response to successful authentication of the particular image capture device further to the discovering, outputting a signal to cause a region of the display to change the icon associated with the particular image capture device from an icon of the first type to an icon of the second type.

According to a fifth aspect, there is provided a non-transitory computer-readable medium comprising computer-readable instructions which, when executed by a processor of a video management server connectable to a network of image capture devices, cause the video management server to carry out a method that comprises: causing a display to illustrate a plurality of icons respectively associated with a plurality of image capture devices, each icon being of a first type or of a second type, each icon of the first type corresponding to an installed but not yet authenticated image capture device and each icon of the second type corresponding to an authenticated image capture device; discovering that a particular image capture device that is an installed but not yet authenticated image capture device has connected to the network; and in response to successful authentication of the particular image capture device further to the discovering, causing the display to change the icon associated with the particular image capture device from an icon of the first type to an icon of the second type.

According to a sixth aspect, there is provided a video management server connectable to a communication network, comprising: a processor; a display operatively coupled to the processor; a memory operatively coupled to the processor and comprising computer-readable instructions executable by the processor; wherein execution of the computer-readable instructions by the processor causes the video management server to carry out a method that comprises: causing the display to illustrate a plurality of icons respectively associated with a plurality of image capture devices, each icon being of a first type or of a second type, each icon of the first type corresponding to an installed but not yet authenticated image capture device and each icon of the second type corresponding to an authenticated image capture device; discovering that a particular image capture device that is an installed but not yet authenticated image capture device has connected to the network; and in response to successful authentication of the particular image capture device further to the discovering, causing the display to change the icon associated with the particular image capture device from an icon of the first type to an icon of the second type.

### BRIEF DESCRIPTION OF THE DRAWINGS

These and other aspects and embodiments will become more readily appreciated as the same become better understood by reference to the following detailed description, when taken in conjunction with the accompanying drawings, which are to be considered non-limiting, and wherein:

FIG. 1 is a block diagram of a video management system comprising a VMS and a plurality of cameras, in accordance with a non-limiting embodiment;

FIG. 2 conceptually illustrates possible contents of a credentials database, in accordance with a non-limiting embodiment;

FIG. 3 is a block diagram showing obtaining of authentication credentials by scanning a label, in accordance with a non-limiting embodiment;

FIG. 4 is a block diagram illustrating discovery of a certain device, possibly a malicious device or possibly a legitimate camera, purporting to have the network device identifier usually associated with the legitimate camera, in accordance with a non-limiting embodiment;

FIG. 5 is a block diagram illustrating authentication of a camera by the VMS;

FIGS. 6A and 6B are flowcharts illustrating an algorithm for authenticating a camera, in accordance with non-limiting embodiments;

FIG. 7 conceptually illustrates possible contents of the credentials database, in accordance with another non-limiting embodiment;

FIG. 8 is an internal block diagram of a VMS, in accordance with a non-limiting embodiment;

FIG. 9 is a flowchart illustrating a process for updating a display of icons based on authentication of an installed camera, in accordance with a non-limiting embodiment;

FIGS. 10A and 10B show a display of icons before and after authentication of a particular camera, in accordance with a non-limiting embodiment;

FIGS. 11A and 11B show a display of icons before and after authentication of a particular camera, in accordance with another non-limiting embodiment; and

FIG. 12 is an internal block diagram of a camera, in accordance with a non-limiting embodiment.

### DETAILED DESCRIPTION

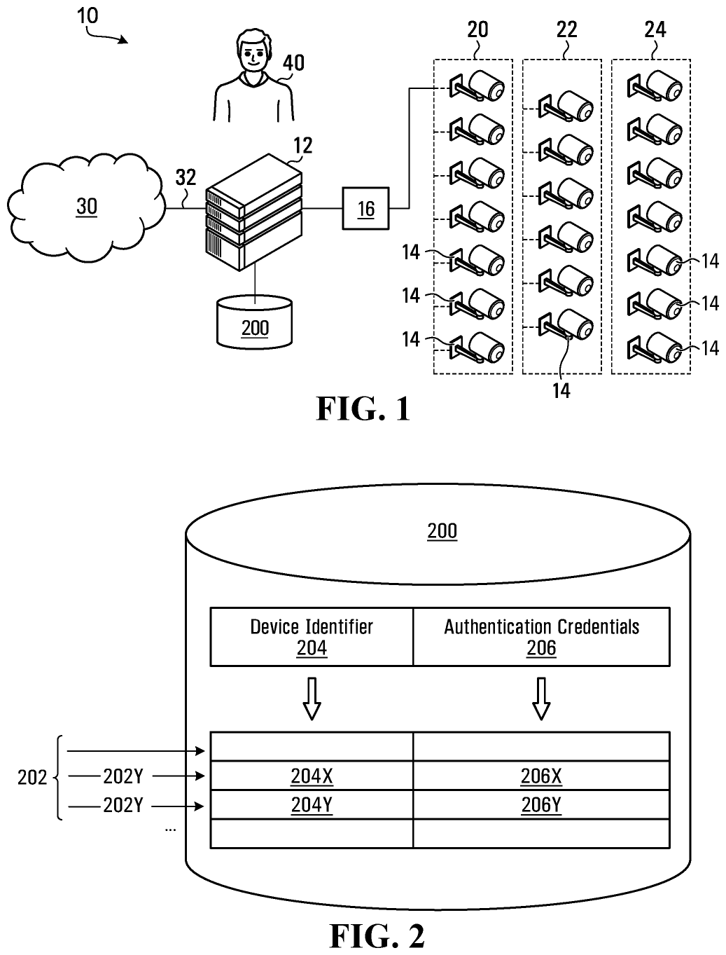

With reference to FIG. 1, there is shown a video management system 10 comprising a video management server (VMS) 12 and a plurality of image capture devices (cameras) 14. Each of the cameras 14 may be a video camera or a still image camera. Suitable cameras may be based on a variety of commercially available models made by a variety of manufacturers. The VMS 12 may be based on an existing system such as Genetec™ Security Center.

The cameras 14 may be logically grouped into three subsets 20, 22, 24.

A first subset 20 of the cameras 14 may already be in secure communication with the VMS 12 over a local communication network 16 (such as a local area network, a passive optical network, a coaxial cable network or the like). The cameras 14 in the first subset 20 may be considered “authenticated” cameras, as they will have gone through an authentication process as will be described later on in this document.

A second subset 22 of the cameras 14 may be physically connected to the local communication network 16 (i.e., installed) but not yet in secure communication with the VMS 12. The cameras 14 in the second subset 22 may be considered “installed but not yet authenticated” cameras.

A third subset 24 of the cameras 14 may not yet be connected to the local communication network 16; the cameras 14 in the third subset 24 may be considered “uninstalled cameras” and they may reside in their original packaging such as a box or wrapped in plastic. Initially, all cameras are uninstalled and not yet connected, and therefore external, to the local communication network 16.

Non-limiting embodiments of the present disclosure deal with, in particular, a given camera's transition from the third subset 24 (uninstalled) to the second subset 22 (installed but not yet authenticated), and then to the first subset 20 (authenticated).

The VMS 12 may be connected to a public data network 30 (e.g., the internet) over a communication link 32, thus allowing the VMS 12 to communicate with entities such as domain name servers, routers and web servers over the internet. The communication link 32 may include a modem, router, switch, or any other component or combination of components needed to establish communication over the public data network 30. However, the local communication network 16 (between the VMS 12 and the authenticated cameras (first subset 20) and the installed but not yet authenticated cameras (second subset 22)) may be isolated from the public data network 30. For example, the local communication network 16 may be a closed-circuit, in-building communication network allowing communication between the VMS 12 and the authenticated cameras (first subset 20) and the installed but not yet authenticated cameras (second subset 22), but not allowing any of these cameras to communicate over a public data network such as the public data network 30 (e.g., the internet). The local communication network 16 may include routers, switches, splitters, buffers and any other components needed to communicate between the VMS 12 and the authenticated cameras (first subset 20) and the installed but not yet authenticated cameras (second subset 22). Although wireless capability is not excluded, the local communication network 16 will tend to be a fixed, wired network for added security.

In some embodiments, each of the cameras 14 is associated with various information elements, including a first information element and a second information element.

The first information element comprises a network device identifier. The network device identifier is used for uniquely identifying each of the cameras 14 to those entities wishing to communicate with it, and therefore a unique network device identifier exists for each of the cameras 14. Non-limiting examples of the network device identifier associated with each of the cameras 14 include a MAC (media access control) address or an IP (internet protocol) address. Another non-limiting example of the network device identifier associated with each of the cameras 14 could be a serial number.

The second information element comprises authentication credentials that are used in a process of authenticating each of the cameras 14 for secure communication with the VMS 12.

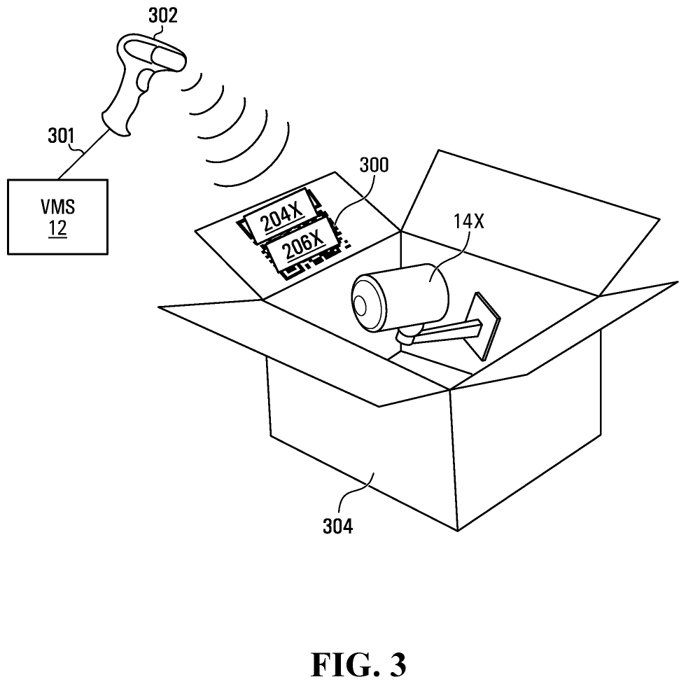

The network device identifier and the authentication credentials for various ones of the cameras 14 may be stored together in a database. Accordingly, the video management system 10 may, in addition to the VMS 12, include a “credential database” 200, either internal to the VMS 12 or operatively coupled to the VMS 12 and to which the VMS 12 has secure access. With reference to FIG. 2, the credential database 200 is depicted as comprising a table of records 202, each record corresponding to a respective one of the cameras 14 and having an entry in a network device identifier field 204 and an entry in an authentication credentials field 206.

There are various ways in which the records 202 of the credential database 200 may be populated. In one example, a user 40 of the VMS 12 reads, scans or otherwise obtains the network device identifier 204X of a particular camera 14X. In addition, the user 40 of the VMS 12 reads, scans or otherwise obtains the associated authentication credentials 206X. Finally, the user 40 creates a record 202X for the particular camera 14X in the table, and populates the record 202X with the network device identifier 204X of the particular camera 14X and the associated authentication credentials 206X.

In another example, the VMS 12 may have pre-populated the table with a list of network device identifiers of a plurality of cameras (e.g., as obtained from a camera manufacturer) and then the user 40 of the VMS 12, upon reading, scanning or otherwise obtaining the network device identifier 204X and the authentication credentials 206X of the particular camera 14X, identifies the matching record 202X for that network device identifier 204X and fills the remainder of the record 202X for the particular camera 14X with the authentication credentials 206X.

It will be appreciated that the authentication credentials 206X associated with the network device identifier 204X of the particular camera 14X are obtained from a source that is external to the local communication network 16. More specifically, FIG. 3 conceptually shows how the authentication credentials 206X may be obtained by optically scanning a label 300 that encodes the authentication credentials 206X. The label 300 may show a bar code or a QR code, for example. In some cases, the label 300 may encode not only the authentication credentials 206X but also the network device identifier 204X associated with the particular camera 14X.

A handheld scanner 302 or mobile device (e.g., a smartphone) in secure communication with the VMS 12 over a wired or wireless link 301 can be used to capture an image of the label 300. Image capture may also be implemented using one of the already authenticated cameras (in the first subset 20). The label 300 may be present on a physical component such as a container (e.g., box 304) containing the particular camera 14X, or may be embodied as a sticker affixed to the particular camera 14X or to wrapping that envelops the particular camera 14X. In other embodiments, wireless (e.g., NFC or RFID) technology could be used to obtain the authentication credentials 206X from an emitter on the particular camera 14X or its box 304, in each case from a source that is external to the local communication network 16 and is associated with a network device identifier 204X.

In still other embodiments, a USB key that stores the authentication credentials 206X may be provided with the particular camera 14X and plugged into the VMS 12 to extract the authentication credentials 206X. In still other embodiments, the authentication credentials 206X are printed on the particular camera 14X or on a piece of paper that accompanies the particular camera 14X and entered manually by a user of the VMS 12. Here too, the USB key or the piece of paper act as a source that is external to the local communication network 16 and provides authentication credentials 206X associated with network device identifier 204X.

Consider now the case where a given camera 14Y, for which a particular network device identifier 204Y and associated authentication credentials 206Y are stored in a record 202Y in the credential database 200, is installed and connected to the local communication network 16. In other words, as a result of its installation, the given camera 14Y transitions from the third subset 24 to the second subset 22. Once connected, the given camera 14Y is now capable of communicating with the VMS 12 over the local communication network 16.

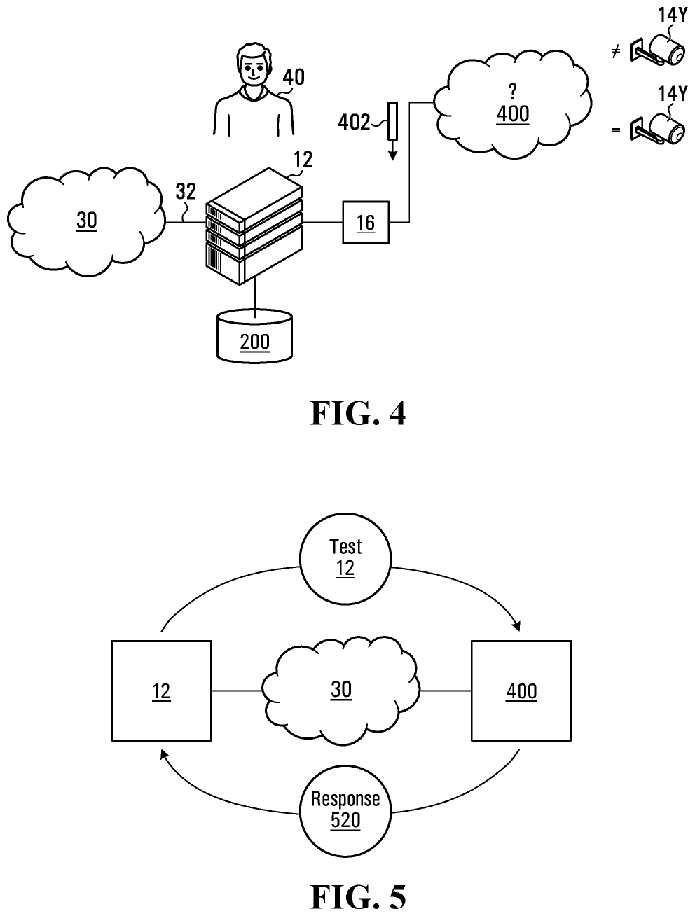

However, the given camera 14Y is not yet authenticated and thus any communication between the given camera 14Y and the VMS 12 is for the time being considered unsecured. An example procedure whereby the VMS 12 secures the installed but unauthenticated camera 14Y, thereby transitioning it from the second subset 22 into the first subset 20, is now described with reference to the diagram in FIG. 4.

In particular, the VMS 12 is configured to determine that a “certain device” 400 purporting to have the particular network device identifier 204Y (which is the network device identifier of the given camera 14Y) is connected to the local communication network 16. From the point of view of the VMS 12, it does not yet have confirmation that the certain device 400, which is purported to have the particular network device identifier 204Y, is indeed the given camera 14Y, hence the need for an authentication process.

The VMS 12 may learn of the particular network device identifier 204Y in various ways:
The certain device 400 may send a message 402 comprising the particular network device identifier 204Y to identify itself to the VMS 12 in an unsolicited manner or on demand from the VMS 12, e.g., in the context of executing a discovery protocol (such as Simple Service Discovery Protocol (SSDP), Universal Plug and Play (UPnP) or Bonjour). In a legitimate scenario, the certain device 400 is the given camera 14Y, whereas in a non-legitimate scenario, the certain device 400 may be a malicious device attempting to spoof the given camera 14Y by using the particular network device identifier 204Y to identify itself to the VMS 12;
The user 40 of the VMS 12 may input to the VMS 12 the particular network identifier 204Y in order to indicate that the given camera 14Y has been connected to the local communication network 16. In a legitimate scenario, the given camera 14Y is truly connected to the local communication network 16 and is the only device on the network 16 using the particular network device identifier 204Y, whereas in a non-legitimate scenario, a malicious device may be connected to the local communication network 16 instead of (or in addition to) the given camera 14Y.

It is noted that in either case, from the perspective of the VMS 12, just because the VMS 12 is alerted to the fact that a certain device 400 purported to have the particular network device identifier 204Y of the given camera 14Y has been connected to the local communication network 16 does not mean that the VMS 12 can be sure that the certain device 400 is the given camera 14Y. In fact, the VMS 12 does not know that the certain device 400 actually is the given camera 14Y until an authentication process is carried out.

The authentication process may in one embodiment involve authentication of the certain device 400 by the VMS 12 or in another embodiment it may involve carrying out a mutual authentication process of both parties (the certain device 400 and the VMS 12). The authentication process (single-sided or mutual) will succeed in a legitimate scenario (i.e., when the certain device 400 is the given camera 14Y), but will fail in a non-legitimate scenario (i.e., when the certain device 400 is not the given camera 14Y).

In an embodiment (single-sided authentication), authentication of the certain device 400 is based on verification that the certain device 400 had prior knowledge of the authentication credentials 206Y, as tested by the VMS 12. For example, the VMS 12 may issue a test 510, and the certain device 400 may issue a response 520. The contents of the response 520 allows the VMS 12 to assess (i.e., prove or disprove) prior knowledge of the authentication credentials 206Y by the certain device 400. In another embodiment (mutual authentication), the mutual authentication process between the VMS 12 and the certain device 400 is based on verification of prior mutual knowledge of the authentication credentials 206Y. In either case, the authentication process (single-sided or mutual) is carried out without actually exchanging the authentication credentials 206Y with the certain device 400 over the local communication network 16.

The one-sided authentication process will be deemed a success (and the certain device 400 will be deemed authenticated as the given camera 14Y) in case the VMS 12 verifies that the certain device 400 had prior knowledge of the authentication credentials 206Y. The mutual authentication process will be deemed a success (and the certain device 400 will be deemed authenticated as the given camera 14Y) in case (i) the VMS 12 verifies that the certain device 400 had prior knowledge of the authentication credentials 206Y and (ii) the certain device 400 verifies that the VMS 12 also had prior knowledge of the authentication credentials 206Y.

In a specific example, knowledge may be considered “prior knowledge” (and therefore leading to successful authentication) when such knowledge is determined to have been gained before execution of the authentication process. In another specific example, by prior knowledge is meant knowledge that is determined to have been obtained at least prior to determining that the certain device 400 is connected to the local communication network 16.

In one embodiment of the mutual authentication process, the verification by the VMS 12 that the certain device 400 had prior knowledge of the authentication credentials 206Y is done before the verification by the certain device 400 that the VMS 12 had prior knowledge of the authentication credentials 206Y. The reason for this is to prevent, in the case where the certain device 400 is a malicious device (i.e., not the given camera 14Y), the VMS 12 from communicating information to the certain (malicious) device 400 that is processed by the malicious device before it has been concluded that the certain device 400 is not the given camera 14Y. However, this ordering in the steps of the mutual authentication process is not a requirement of all embodiments.

One non-limiting example of the mutual authentication process involves the VMS 12 and the certain device 400 carrying out a PAKE (password-authenticated key exchange) protocol, as described in Anitha Kumari K et a., “Solution to Security and Secrecy in Cloud Environment using PAKE Protocol—A Bibliographic Survey”, International Journal of Computer Applications (0975-8887), Vol. 96, No. 2, June 2014, hereby incorporated by reference herein.

According to another non-limiting example of the mutual authentication process, the bar code or QR code embedded/encoded in the label 300 may include a public key of the certain device 400. This public key is then used to establish an HTTPS link with the certain device 400, allowing the VMS 12 to authenticate the certain device 400 as the given camera 14Y, or not. Assuming that the certain device 400 is indeed successfully authenticated as the given camera 14Y, the same HTTPS link can then also be used by the VMS 12 to transmit a password to the given camera 14Y, allowing the given camera 14Y to authenticate the VMS 12 if the password corresponds to an expected password for the VMS 12.

According to yet another non-limiting example of the mutual authentication process, the bar code or QR code embedded/encoded in the label 300 (e.g., a 1^{st} QR code) includes a public key of the certain device 400, and the VMS 12 transmits a 2^{nd} QR code containing a public key of the VMS 12 to the certain device 400. This 2^{nd} QR code may be transmitted to a smartphone that is placed in front of the certain device 400 so as to be captured by the certain device 400. In this way, mutual authentication can be achieved by using two public keys without resorting to any passwords.

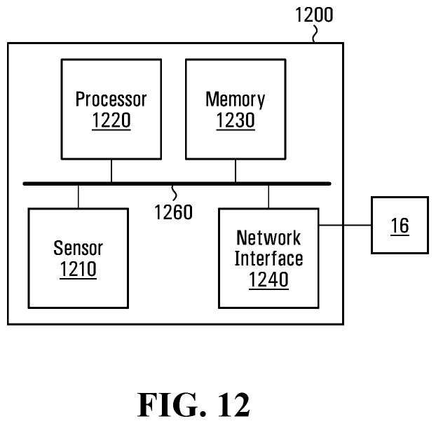

FIG. 12 shows in greater detail the certain device 400 embodied as a camera 1200. The camera 1200 has a sensor 1210 for capturing still or video images, a processor 1220, a memory 1230 and a network interface 1240 for connection to a network such as the local communication network 16. These various components are operatively coupled via a communication bus 1260. The memory 1230 comprises computer-readable instructions executable by the processor 1220. By the processor 1220 executing the computer-readable instructions in the memory 1230, the camera 1200 is configured to carry out various processes. A first such process may involve implementing a communications protocol with an entity (such as the VMS 12) via the network interface 1240. A second such process may involve processing images captured by the sensor 1210, formatting them into packets and transmitting the packets via the network interface 1240. As such, the second process may utilize (e.g., call) the first process.

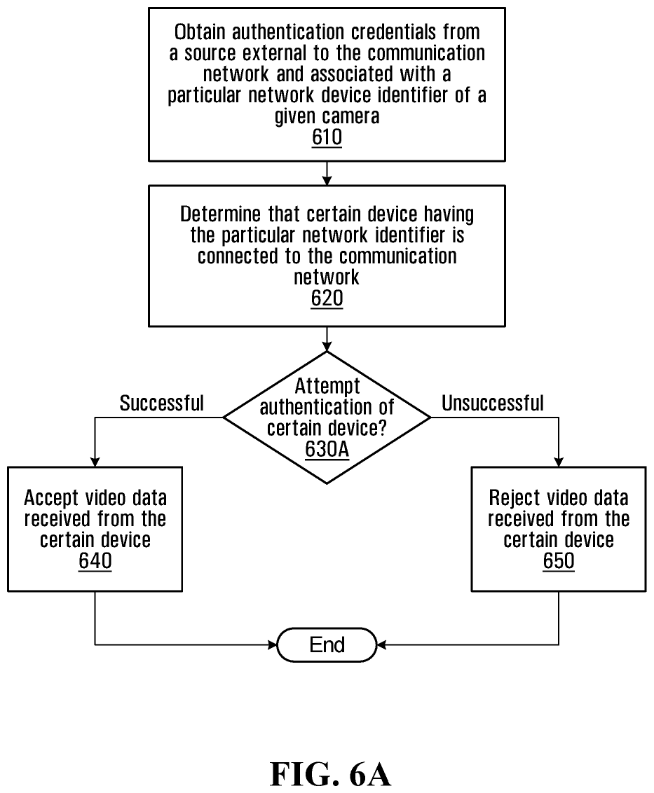

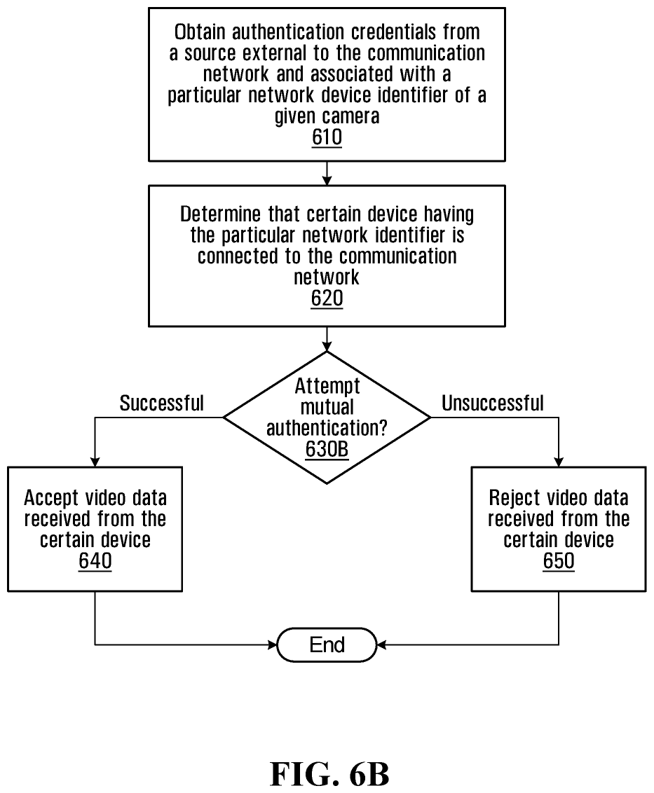

In summary, it will be appreciated that the VMS 12 carries out an algorithm or method that can be described with reference to the flowcharts in FIGS. 6A and 6B, wherein at step 610, the VMS 12 obtains authentication credentials from a source external to a communication network (e.g., the local communication network 16). The authentication credentials are associated with a particular network device identifier of a given image capture device (e.g., camera). At step 620, the VMS 12 determines that a certain device having the particular network device identifier is connected to the communication network 16. Then, after the determining, the VMS 12 attempts either authentication of the certain device (step 630A in FIG. 6A) or a mutual authentication with the certain device (step 630B in FIG. 6B) over the communication network based on verification of either prior knowledge of the authentication credentials by the certain device (FIG. 6A) or prior mutual knowledge of the authentication credentials by both parties (FIG. 6B). If the authentication at step 630A (or the mutual authentication at step 630B) is successful, then at step 640, the VMS 12 accepts video data received from the certain device over the communication network if. If the authentication/mutual authentication at step 630A/630B is not successful, then at step 650, the VMS rejects video data received from the certain device over the communication network.

It is noted that in various embodiments, rejecting the data (step 650) could involve deleting, quarantining or rerouting video data received from the given camera 14Y over the local communication network 16.

It is noted that accepting the data (step 640) could involve processing video data received from the given camera 14Y over the local communication network 16 in accordance with certain “video provisioning parameters”. The video provisioning parameters could include one or more of camera manufacturer, camera model, video resolution(s) supported (e.g., 640×480, 800×600, 960×720, 1024×768, 1280×960, 1400×1050, 1440×1080, 1600×1200, 1856×1392, 1920×1440, 2048×1536, etc.) and video codec(s) supported (e.g., H.264, MPEG-4, DivX, MPEG-2, HEVC (H.265), etc.).

The video provisioning parameters allow the VMS 12 to properly process the video data from the given camera 14Y after successful authentication. The video provisioning parameters may be formatted in a standard format such as XML or JSON and included in a QR code or bar code, for example. Other video provisioning parameters may be retrieved by consulting a database (e.g., over the internet) as a function of camera manufacturer and model. A further example of a video provisioning parameter may include the estimated or obtained geographic location of the given camera 14Y.

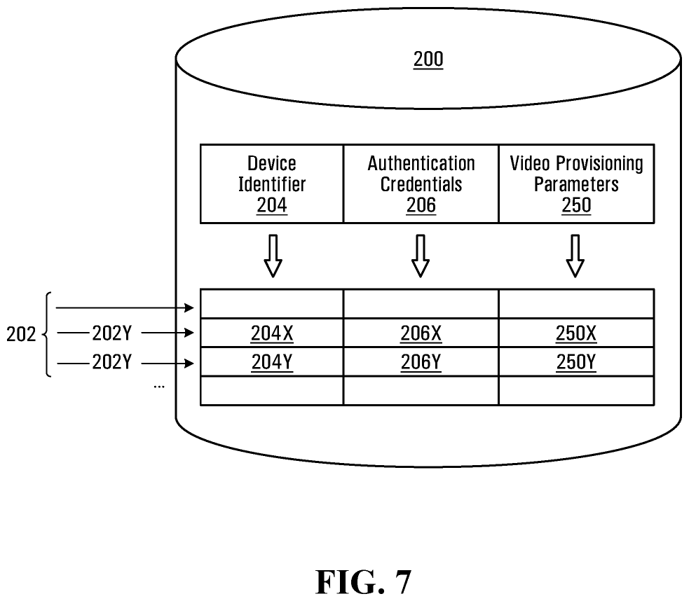

The video provisioning parameters could be associated with the network device identifier 206Y of the given camera 14Y, and they could be stored before the given camera 14Y is even connected to the local communication network 16 (i.e., during an initial provisioning step while the given camera 14Y still belongs to the third subset 24). For example, as seen in FIG. 7, the database 200 can include a video provisioning parameters field 250. As such, the record 202Y stored in the credential database 200 for the given camera 14Y could be expanded to include an entry for storing the video provisioning parameters 250Y. This entry could be populated with the video provisioning parameters 250Y by the VMS 12 accessing this information over the public data network 30 (e.g., at a manufacturer website) based on the network device identifier 204Y (which is non-secret) of the given camera 14Y. Alternatively, the video provisioning parameters 250Y could be sent by the given camera 14Y to the VMS 12 over the local communication network 16 after the authentication process (step 630A/630B) has been deemed a success.

As such, it has been shown that authentication of a camera on the local communication network 16 is carried out based on authentication credentials that did not travel across the local communication network 16, whether at the stage of acquisition by the VMS 12 or at the stage of an authentication process (single-sided or mutual) involving the VMS 12 and the camera. This approach may allow a defense against man-in-the middle type attacks and other attacks that are based on interception of credentials and spoofing.

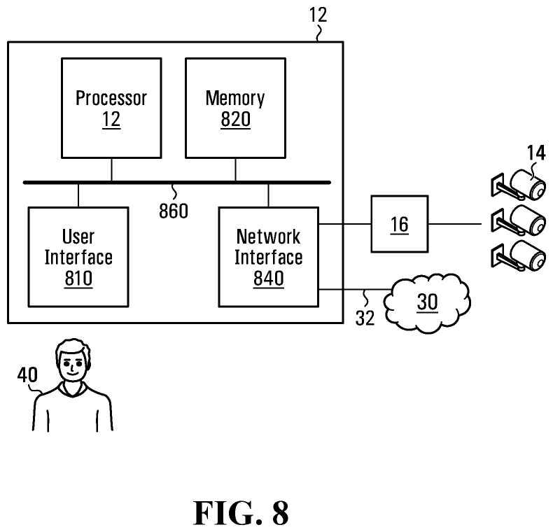

FIG. 8 shows an example video management server (VMS) 12 with a processor 800, a display 810, a memory 820 and a network interface 840, all operatively coupled to one another via a communication bus 860. The memory 820 comprises computer-readable instructions executable by the processor 800. By the processor 800 executing the computer-readable instructions, the VMS 12 carries out various processes, including processes for communicating with the cameras 14 via the network interface 840 and the local communication network 16 (e.g., to carry out authentication) and processes for communicating over the public data network 30 via the network interface 840 and the communication link 32. Other processes involve interacting with the user 40 via a user interface 810 that may include a display.

As such, it can be appreciated that the video management server is connectable to a communication network and includes a processor; an interface; and a memory operatively coupled to the processor and comprising computer-readable instructions executable by the processor. Execution of the computer-readable instructions by the processor causes the video management server to carry out a method that comprises obtaining, via the interface, authentication credentials from a source external to the communication network, the authentication credentials being associated with a particular network device identifier of an image capture device; determining that a certain device purported to have the particular network device identifier is connected to the communication network; after the determining, attempting to authenticate, via the interface, the certain device over the communication network based on verification of prior knowledge of the authentication credentials by the certain device; and accepting, via the interface, video data received from the certain device over the communication network if the authentication is successful.

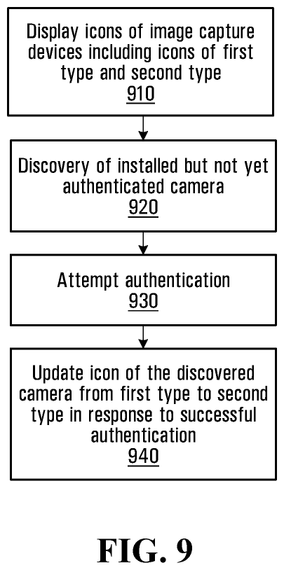

Certain steps of an example process that may be executed by the VMS 12 are shown in FIG. 9 and now described. Specifically, at step 910, the display 810 is caused to illustrate a plurality of icons respectively associated with a plurality of image capture devices (e.g., cameras). Each icon is of a “first type” or of a “second type”. An icon of the first type corresponds to an installed but not yet authenticated camera (subset 22) and an icon of the second type corresponds to a camera that has already been authenticated (subset 20). At step 920, the VMS 12 discovers that a particular camera that is an installed but not yet authenticated image capture device (i.e., associated with an icon of the first type) has connected to the local communication network 16, as has already been described. Then, at step 940, and in response to successful authentication of the particular camera further to the discovering at step 920 (which may involve attempting authentication at step 930), the VMS 12 causes the display 810 to change the icon associated with the particular camera from an icon of the first type to an icon of the second type.

Those skilled in the art will appreciate that for added security, the authentication credentials associated with a particular network device identifier of a given camera may have a limited validity period. The validity period may be measured in terms of time (e.g., hours or days) or it may depend on the number of attempts to use it. For example, as soon as the authentication credentials are used to attempt authentication, their validity period may expire. The validity period may be stored in memory (e.g., in the credentials database 200 as an additional field of each record 202). As such, only a single attempt (or a small number of attempts) may be made with the same authentication credentials for the same network device identifier. This means that a malicious party wanting to infiltrate the VMS 12 using a malicious network device and that somehow accesses the authentication credentials will have only one chance to attempt to authenticate its malicious device using such credentials, which means that it has to act before the camera legitimately associated with these authentication credentials is discovered on the network. The probability of this occurring may be low, because of the timing between physically connecting a malicious device to the network and obtaining access to a set of authentication for a device that has yet to be authenticated.

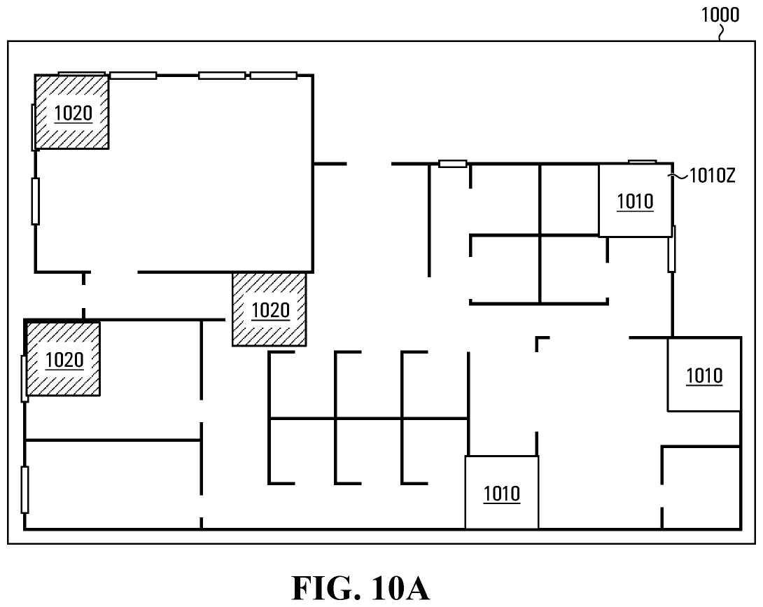

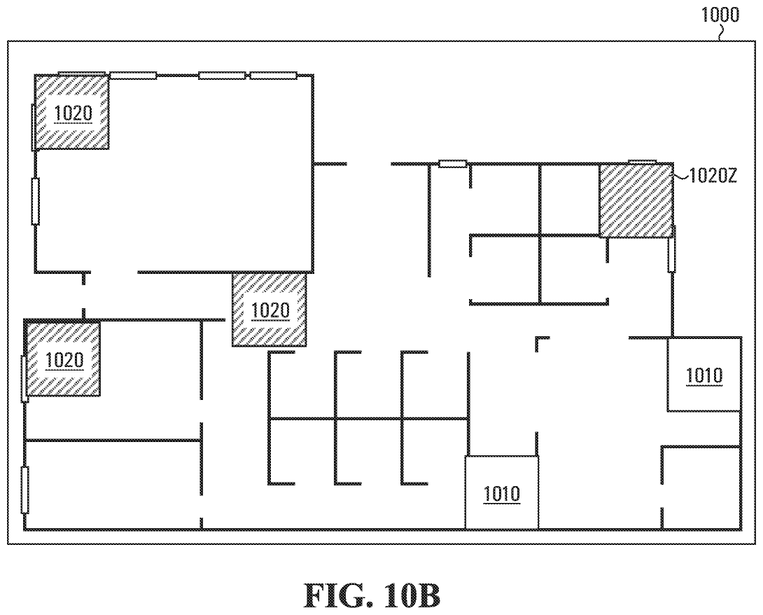

From a graphical and user interface perspective, many possibilities exist. For example, as shown in FIG. 10A, the icons referred to above may be overlaid onto a map 1000, such as an in-building floor plan. Here, the icons include various icons 1010 (i.e., icons of the first type) associated with cameras that are installed but not yet authenticated, as well as various icons 1020 (i.e., icons of the second type) associated with cameras that have already been authenticated. The icons 1010 include a particular icon 1010Z associated with a particular one of the cameras 14 that is installed but not yet authenticated. The icon 1010Z changes to icon 1020Z (see FIG. 10B) upon successful authentication of the associated camera and execution of step 930. The associated camera is thereafter considered part of the first subset 20 and no longer part of the second subset 22.

In the embodiment of FIG. 10A, the icons 1010 were associated to a geographic location on the map 1000, and the position of icon 1010Z did not change as it transformed into icon 1020Z. This lack of change in the geographic location may imply that the geographic location of the associated camera was correct as of the time of installation. In other words, it is possible that the installer registers exactly where on the map 1000 a camera having a particular MAC or IP address appears and thus its location is known at the time of installation and all that is missing is the authentication step. For example, the installer may utilize a smartphone or other mobile device equipped with GPS to scan the camera and/or manually enter the particular network device identifier of the camera, and feed this information back to the VMS 12, together with a current geographic location of the smartphone/mobile device. In this way, the VMS 12 gains knowledge of the correct geographic location of the camera being installed so as to correctly position the icon 1010Z on the map 1000 from the get-go.

However, precise knowledge of the geographic location of the installed camera is not a requirement. For example, it may be through discovery by the VMS 12 that the precise geographic location of the installed camera will become known. In that case, the installer may just indicate that a camera having a particular MAC or IP address (or other network device identifier) has been installed, without providing a specific location. Then, it is upon connecting to the local communication network 16 that the VMS 12 determines where the camera with that MAC or IP address (or other network device identifier) is located and then carries out the authentication. In this case, during the time span between installation of such a camera and its discovery, a “placeholder” icon may be assigned to this camera by the VMS 12.

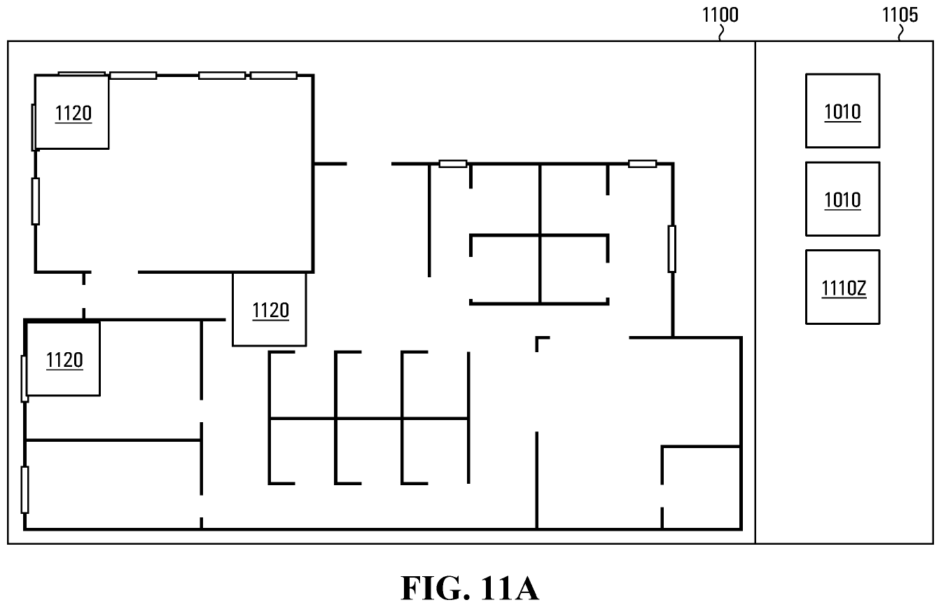

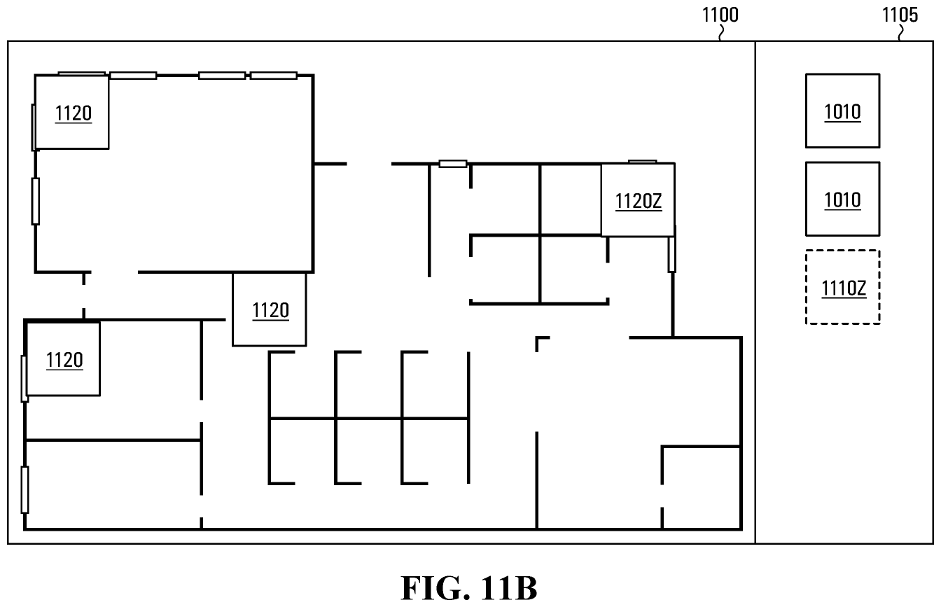

Accordingly, with specific reference to FIG. 11A, it will be seen that icons 1110 (i.e., icons of the first type) are associated with cameras that are installed but not yet authenticated, and that as various icons 1120 (i.e., icons of the second type) are associated with cameras that have already been authenticated. Icons 1120 (of the second type) are placed on a map 1100, similarly to the icons 1020. However, icons 1110 (of the first type) are placed in a separate region 1105 of the screen, not necessarily on the map 1110. The icons 1110, which in this case include a placeholder icon 1110Z associated with a particular one of the cameras 14 that is installed but not yet authenticated, may thus appear to form a list in the region 1105, and may correspond to the cameras 22 in the second subset 22. Upon successful authentication of the corresponding camera and execution of step 930, the placeholder icon 1110Z (see FIG. 11B) disappears from the list 1105 and a new icon 1120Z appears on the map 1100 at the location where the corresponding camera was discovered.

As such, a computer-implemented method for facilitating management of a network of image capture devices is provided, according to which the VMS outputs a signal to cause a display to illustrate a plurality of icons respectively associated with a plurality of image capture devices, each icon being of a first type or of a second type, each icon of the first type corresponding to an installed but not yet authenticated image capture device and each icon of the second type corresponding to an authenticated image capture device. Then, the VMS discovers, through the network, that a particular image capture device that is an installed but not yet authenticated image capture device has connected to the network. Finally, in response to successful authentication of the particular image capture device further to the discovering, the VMS outputs a signal to cause a region of the display to change the icon associated with the particular image capture device from an icon of the first type to an icon of the second type.

Those skilled in the art will appreciate that although the above description has been provided in the context of image capture devices such as cameras, the teachings herein may be applicable to other discoverable network devices, including but not limited to routers, modems and servers, for example.

Although a description of certain example embodiments has been provided, those skilled in the art should appreciate that numerous variants and modifications are possible and that the scope of the invention is limited only by the scope of the claims appended hereto. Also, it should be appreciated that not all features are required in all embodiments.

1. A method for execution by a video management server connectable to a communication network, comprising:
obtaining authentication credentials from a source external to the communication network, the authentication credentials being associated with a particular network device identifier of an image capture device;
determining that a certain device purported to have the particular network device identifier is connected to the communication network;
after the determining, attempting to authenticate the certain device over the communication network based on verification of prior knowledge of the authentication credentials by the certain device; and
accepting video data received from the certain device over the communication network if the attempting to authenticate is successful.

2. The method defined in claim 1, further comprising determining that the attempting to authenticate is successful in case the video management server determines that the authentication credentials were known to the certain device prior to the determining.

3. The method defined in claim 1, further comprising determining that the attempting to authenticate is successful in case the video management server determines that the authentication credentials were known to the certain device prior to execution of the method.

4. The method defined in claim 1, wherein the accepting video data received from the certain device occurs only if the attempting to authenticate is successful.

5. The method defined in claim 1, further comprising, after the determining, attempting a mutual authentication with the certain device over the communication network based on verification of prior mutual knowledge of the authentication credentials by the video management server and the certain device, wherein attempting to authenticate the certain device is included as part of the mutual authentication.

6. The method defined in claim 5, wherein the accepting video data received from the certain device occurs only if the mutual authentication is successful.

7. The method defined in claim 1, wherein obtaining the authentication credentials from the source external to the communication network comprises optically scanning a physical component external to the communication network to obtain an image.

8. The method defined in claim 7, wherein the physical component includes one of a container for containing the image capture device and a label for being affixed to the image capture device.

9. The method defined in claim 8, wherein the image includes a scan of a QR code.

10. The method defined in claim 1, wherein obtaining the authentication credentials comprises scanning an image into which the authentication credentials have been encoded.

11. The method defined in claim 1, further comprising obtaining the particular network device identifier together with the authentication credentials.

12. The method defined in claim 11, further comprising storing the particular network device identifier and the authentication credentials in association with each other in a database.

13. The method defined in claim 1, further comprising determining provisioning parameters associated with the particular network device identifier.

14. The method defined in claim 13, wherein determining the provisioning parameters occurs between the obtaining and the determining.

15. The method defined in claim 13, wherein the provisioning parameters include video provisioning parameters.

16. The method defined in claim 15, wherein the video provisioning parameters include a geographic location of the camera.

17. The method defined in claim 16, wherein accepting the video data received from the certain device over the communication network comprises processing the video data in accordance with the video provisioning parameters.

18. The method defined in claim 5, wherein the mutual authentication is carried out without exchanging the authentication credentials with the certain device over the communication network.

19. The method defined in claim 5, wherein said attempting the mutual authentication is at least partly carried out in accordance with a PAKE protocol with the certain device.

20. The method defined in claim 5, wherein said attempting the mutual authentication comprises the video management server providing a first public key to the certain device and the certain device providing a second public key to the video management server.

21. The method defined in claim 5, wherein the mutual authentication is deemed successful in case (i) the video management server verifies that the certain device had prior knowledge of the authentication credentials and (ii) the certain device verifies that the video management server had prior knowledge of the authentication credentials.

22. The method defined in claim 5, wherein the mutual authentication is deemed successful in case (i) the video management server verifies that the certain device had knowledge of the authentication credentials prior to the determining and (ii) the certain device verifies that the video management server had knowledge of the authentication credentials prior to the determining.

23. The method defined in claim 1, wherein determining that the certain device is connected to the communication network comprises carrying out a discovery protocol.

24. The method defined in claim 1, wherein determining that the certain device is connected to the communication network comprises receiving a message from the certain device over the communication network, the message comprising the particular network device identifier.

25. The method defined in claim 1, wherein determining that the certain device is connected to the communication network comprises receiving input from an operator of the video management server, the input specifying the particular network device identifier.

26. The method defined in claim 1, wherein the particular network device identifier is at least one of a MAC address and an IP address.

27. The method defined in claim 5, further comprising rejecting video data received from the certain device over the communication network if the mutual authentication is not successful.

28. The method defined in claim 5, wherein the mutual authentication is deemed not successful in case video management server did not have knowledge of the authentication credentials prior to the determining or the video management server determines that the certain device did not have knowledge of the authentication credentials prior to the determining.

29. The method defined in claim 1, wherein the communication network is an in-building, closed-circuit network.

30. The method defined in claim 1, wherein the communication network is isolated from the Internet.

31. A video management server connectable to a communication network, comprising:
a processor;
an interface;
a memory operatively coupled to the processor and comprising computer-readable instructions executable by the processor;
wherein execution of the computer-readable instructions by the processor causes the video management server to carry out a method that comprises:
obtaining, via the interface, authentication credentials from a source external to the communication network, the authentication credentials being associated with a particular network device identifier of an image capture device;
determining that a certain device purported to have the particular network device identifier is connected to the communication network;
after the determining, attempting, via the interface, a mutual authentication with the certain device over the communication network based on verification of prior knowledge of the authentication credentials by the certain device; and
accepting, via the interface, video data received from the certain device over the communication network if the authentication is successful.

32. A non-transitory computer-readable medium comprising computer-readable instructions which, when executed by a processor of a video management server connectable to a communication network, cause the video management server to carry out a method that comprises:
obtaining authentication credentials from a source external to the communication network, the authentication credentials being associated with a particular network device identifier of an image capture device;
determining that a certain device purported to have the particular network device identifier is connected to the communication network;
after the determining, attempting a mutual authentication with the certain device over the communication network based on verification of prior knowledge of the authentication credentials by the certain device; and
accepting data received from the certain capture device over the communication network if the authentication is successful.

33-72. (canceled)
